(19) United States
(12) Patent Application Publication
(10) Pub. No.: US 2026/0292031 A1
(43) Pub. Date: Sep. 24, 2026

(54) METHODS FOR MEASUREMENT OF XR INTERACTIVITY QUALITY OF EXPERIENCE

(71) Applicant: InterDigital CE Patent Holdings, SAS, Paris (FR)

(72) Inventors: Loic Fontaine, Noyal sur Vilaine (FR); Patrice Hirtzlin, Betton (FR); Stephane Onno, Saint Gregoire (FR); Etienne Faivre d'Arcier, Saint Gonlay (FR); Pierrick Jouet, Rennes (FR); Sylvain Lelievre, Montgermont (FR)

(21) Appl. No.: 19/473,046

(22) PCT Filed: Mar. 25, 2024
(86) PCT No.: PCT/EP2024/057980

§ 371 Date: Oct. 6, 2025

(30) Foreign Application Priority Data
Apr. 7, 2023 (EP) 23305520.1

(51) Int. Cl. H04L 67/131; G06T 19/00; H04L 43/0864

(52) U.S. Cl. CPC H04L 67/131; G06T 19/006; H04L 43/0864

(57) ABSTRACT

Some embodiments of a method may include configuring a metadata structure to manage processing of received inter-actions with respect to an MR scene, the metadata structure comprising a series of time information determinations in processing the received interaction; receiving a user action and initiating processing of an interaction request based on the user action; determining a first time information at a first stage of the processing of the interaction request; updating the interaction information with the first time information at the first stage; sending the interaction request to the server with the updated interaction information; receiving a response to the interaction request, the response comprising further interaction information that comprises the updated interaction information and further time information from the server in accordance with the metadata structure; and determining one or more Quality of Experience (QoE) metrics based at least in part on the updated further interaction information.

### CROSS-REFERENCE TO RELATED APPLICATIONS

This application claims benefit of European Patent Application No. EP23305520, filed Apr. 7, 2023, entitled “METHODS FOR MEASUREMENT OF XR INTERACTIVITY QUALITY OF EXPERIENCE,” which is hereby incorporated by reference in its entirety.

### BACKGROUND

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way which is consistent with the user context (environment, point of view, device, etc.). Scene graphs (such as the one proposed by Khronos/gITF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand.

Although such scene description frameworks ensure that the timed media and the corresponding relevant virtual content are available at any time during the rendering of the application, such frameworks do not provide a description of how a user can interact with the scene objects at runtime for immersive XR experiences. Hence, there is no support of user specific XR experiences for consuming the immersive media.

### SUMMARY

An example method in accordance with some embodiments may include communicating, by a client device, with a server to configure a metadata structure to manage processing of received interactions with respect to a mixed-reality (MR) scene, the metadata structure comprising a series of time information determinations to be made at the client device and the server device in processing the received interaction; receiving a user action with respect to the MR scene and initiating processing of an interaction request based on the user action in accordance with interaction information corresponding to the user action and with the metadata structure; determining a first time information at a first stage of the processing of the interaction request at the client device; updating the interaction information with the first time information at the first stage; sending the interaction request to the server with the updated interaction information; receiving, from the server, a response to the interaction request, the response comprising further interaction information that comprises the updated interaction information and further time information from the server in accordance with the metadata structure; and determining one or more Quality of Experience (QoE) metrics based at least in part on the updated further interaction information.

Some embodiments of the example method may further include determining a second time information at a second stage of the processing of the interaction request at the client device; and updating the interaction information with the second time information at the second stage.

For some embodiments of the example method, at least one of the first time information and the second time information may include one or more timestamps.

Some embodiments of the example method may further include determining a second time information at a second stage of the processing of the response from the server at the client device; and updating the further interaction information from the response from the server with the second time information at the second stage

Some embodiments of the example method may further include receiving an identifier code; and determining a configuration of the metadata structure based on the received identifier code.

Some embodiments of the example method may further include receiving an identifier code; and using the identifier code to check processing order of user interactions at the server.

Some embodiments of the example method may further include receiving an identifier code; and determining a roundtrip interaction delay using the identifier code.

For some embodiments of the example method, determining the roundtrip interaction delay may include storing a time when a user performed an interaction associated with the identifier code.

Some embodiments of the example method may further include determining an interaction request drop rate, wherein the interaction drop rate may include a rate at which interaction requests are dropped by the server, and wherein the interaction request drop rate may include a QoE metric.

For some embodiments of the example method, at least one of the one or more QoE metrics may be a roundtrip interaction delay.

For some embodiments of the example method, the response may include an updated description of the MR scene.

For some embodiments of the example method, the response may include a new description of the MR scene.

For some embodiments of the example method, the response may include information indicating the interaction request was dropped by the server.

For some embodiments of the example method, the response may include an encoded version of a rendered MR scene.

For some embodiments of the example method, the further time information may further include from stages of processing at the server.

An example apparatus in accordance with some embodiments may include a processor; and a non-transitory computer-readable medium storing instructions operative, when executed by the processor, to cause the apparatus to perform one of the methods listed above.

An additional example method in accordance with some embodiments may include receiving, by a server, communications from a client device, to configure a metadata structure to manage processing of user interactions with respect to a mixed-reality (MR) scene, the metadata structure comprising a series of time information determinations to be made at the client device and the server device in processing the received interaction; receiving, at the server, an interaction request with interaction information, wherein the interaction information comprises a first time information at a first stage of processing of the interaction request at the client device; determining, at the server, a further time information at a second stage of the processing of the interaction request; sending, to the client device, a response to the interaction request, the response comprising further interaction information that comprises the interaction information and the further time information from the server in accordance with the metadata structure; wherein one or more Quality of Experience (QoE) metrics are based at least in part on the further interaction information.

For some embodiments of the additional example method, at least one of the first time information and the further time information may include one or more timestamps.

Some embodiments of the additional example method may further include receiving an identifier code; and determining a configuration of the metadata structure based on the received identifier code.

Some embodiments of the additional example method may further include receiving an identifier code; and using the identifier code to check processing order of user interactions at the server.

Some embodiments of the additional example method may further include receiving an identifier code; and determining a user interaction delay using the identifier code.

For some embodiments of the additional example method, determining the user interaction delay may include receiving a time when a user performed an interaction associated with the identifier code.

Some embodiments of the additional example method may further include determining an interaction request drop rate, wherein the interaction drop rate may include a rate at which interaction requests are dropped by the server, and wherein the interaction request drop rate may include a QoE metric.

For some embodiments of the additional example method, at least one of the one or more QoE metrics may be a user interaction delay.

For some embodiments of the additional example method, the response may include an updated description of the MR scene.

For some embodiments of the additional example method, the response may include a new description of the MR scene.

For some embodiments of the additional example method, the response may include information indicating the interaction request was dropped by the server.

For some embodiments of the additional example method, the response may include an encoded version of a rendered MR scene.

For some embodiments of the additional example method, the further time information may further include from stages of processing at the server.

Some embodiments of the additional example method may further include receiving the one or more Quality of Experience (QoE) metrics that are based at least in part on the further interaction information.

An additional example apparatus in accordance with some embodiments may include a processor; and a non-transitory computer-readable medium storing instructions operative, when executed by the processor, to cause the apparatus to perform any one of the claims listed above.

### BRIEF DESCRIPTION OF THE DRAWINGS

FIG. 1A is a schematic side view illustrating an example waveguide display that may be used with extended reality (XR) applications according to some embodiments.

FIG. 1B is a schematic side view illustrating an example alternative display type that may be used with extended reality applications according to some embodiments.

FIG. 1C is a schematic side view illustrating an example alternative display type that may be used with extended reality applications according to some embodiments.

FIG. 1D is a system diagram illustrating an example set of interfaces for a system according to some embodiments.

FIG. 2 is a system diagram illustrating an example set of interfaces for an MPEG-I node hierarchy supporting elements of scene interactivity according to some embodiments.

FIG. 3 is a system diagram illustrating an example set of interfaces for standalone augmented reality (STAR)-based 5G interactive immersive service according to some embodiments.

FIG. 4 is a system diagram illustrating an example set of interfaces for EDGe-dependent AR (EDGAR)-based 5G interactive immersive service according to some embodiments.

FIG. 5 is a message sequencing diagram illustrating an example process for user interaction with a standalone XR device according to some embodiments.

FIG. 6 is a message sequencing diagram illustrating an example process for user interaction with an XR edge server with split rendering according to some embodiments.

FIG. 7 is a flowchart illustrating an example process for determining a quality of experience metric according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

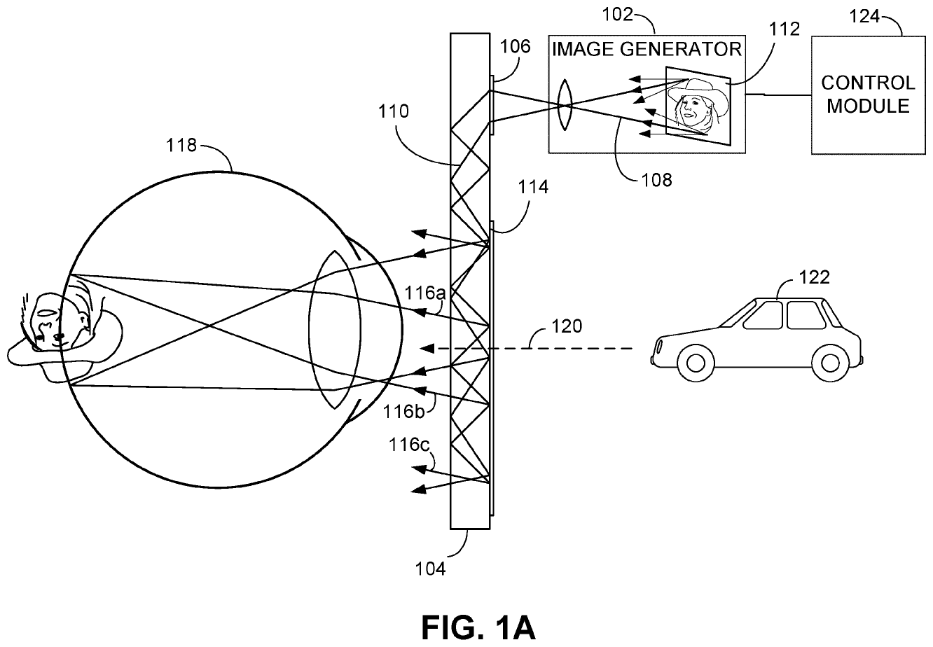

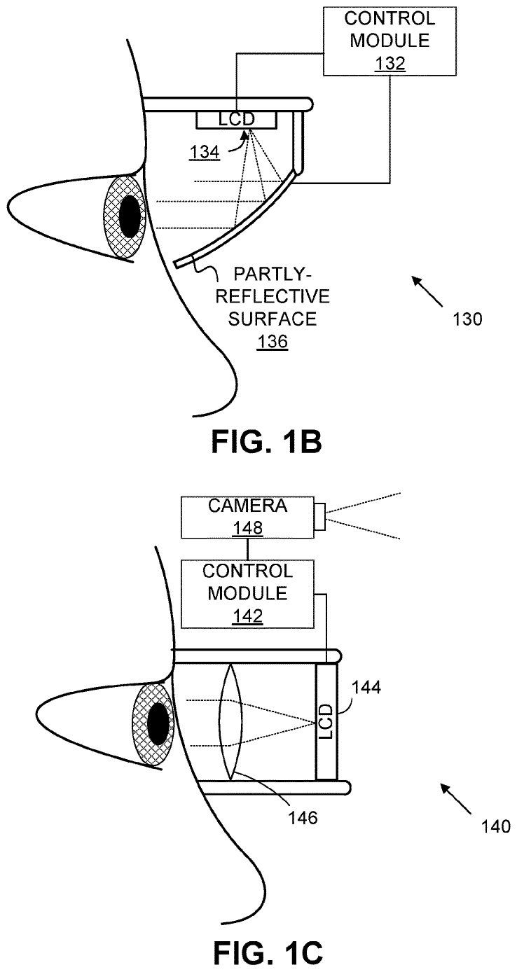

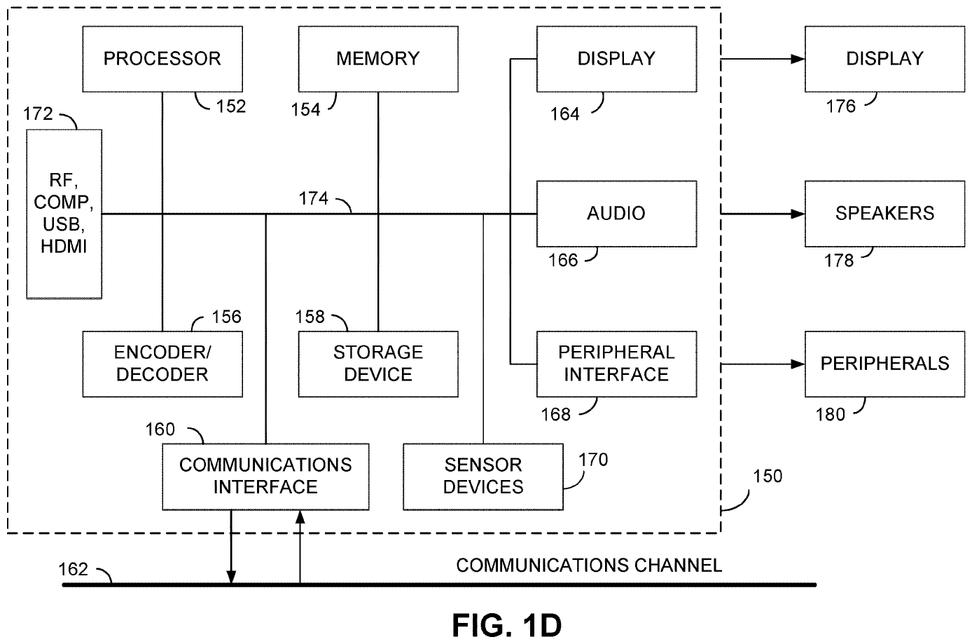

FIG. 1A is a schematic side view illustrating an example waveguide display that may be used with extended reality (XR) applications according to some embodiments. An image is projected by an image generator 102. The image generator 102 may use one or more of various techniques for projecting an image. For example, the image generator 102 may be a laser beam scanning (LBS) projector, a liquid crystal display (LCD), a light-emitting diode (LED) display (including an organic LED (OLED) or micro LED (μLED) display), a digital light processor (DLP), a liquid crystal on silicon (LCoS) display, or other type of image generator or light engine.

Light representing an image 112 generated by the image generator 102 is coupled into a waveguide 104 by a diffractive in-coupler 106. The in-coupler 106 diffracts the light representing the image 112 into one or more diffractive orders. For example, light ray 108, which is one of the light rays representing a portion of the bottom of the image, is diffracted by the in-coupler 106, and one of the diffracted orders 110 (e.g. the second order) is at an angle that is capable of being propagated through the waveguide 104 by total internal reflection. The image generator 102 displays images as directed by a control module 124, which operates to render image data, video data, point cloud data, or other displayable data.

At least a portion of the light 110 that has been coupled into the waveguide 104 by the diffractive in-coupler 106 is coupled out of the waveguide by a diffractive out-coupler 114. At least some of the light coupled out of the waveguide 104 replicates the incident angle of light coupled into the waveguide. For example, in the illustration, out-coupled light rays 116a, 116b, and 116c replicate the angle of the in-coupled light ray 108. Because light exiting the out-coupler replicates the directions of light that entered the in-coupler, the waveguide substantially replicates the original image 112. A user's eye 118 can focus on the replicated image.

In the example of FIG. 1A, the out-coupler 114 out-couples only a portion of the light with each reflection allowing a single input beam (such as beam 108) to generate multiple parallel output beams (such as beams 116a, 116b, and 116c). In this way, at least some of the light originating from each portion of the image is likely to reach the user's eye even if the eye is not perfectly aligned with the center of the out-coupler. For example, if the eye 118 were to move downward, beam 116c may enter the eye even if beams 116a and 116b do not, so the user can still perceive the bottom of the image 112 despite the shift in position. The out-coupler 114 thus operates in part as an exit pupil expander in the vertical direction. The waveguide may also include one or more additional exit pupil expanders (not shown in FIG. 1A) to expand the exit pupil in the horizontal direction.

In some embodiments, the waveguide 104 is at least partly transparent with respect to light originating outside the waveguide display. For example, at least some of the light 120 from real-world objects (such as object 122) traverses the waveguide 104, allowing the user to see the real-world objects while using the waveguide display. As light 120 from real-world objects also goes through the diffraction grating 114, there will be multiple diffraction orders and hence multiple images. To minimize the visibility of multiple images, it is desirable for the diffraction order zero (no deviation by 114) to have a great diffraction efficiency for light 120 and order zero, while higher diffraction orders are lower in energy. Thus, in addition to expanding and out-coupling the virtual image, the out-coupler 114 is preferably configured to let through the zero order of the real image. In such embodiments, images displayed by the waveguide display may appear to be superimposed on the real world.

FIG. 1B is a schematic side view illustrating an example alternative display type that may be used with extended reality applications according to some embodiments. In an XR head-mounted display device 130, a control module 132 controls a display 134, which may be an LCD, to display an image. The head-mounted display includes a partly-reflective surface 136 that reflects (and in some embodiments, both reflects and focuses) the image displayed on the LCD to make the image visible to the user. The partly-reflective surface 136 also allows the passage of at least some exterior light, permitting the user to see their surroundings.

FIG. 1C is a schematic side view illustrating an example alternative display type that may be used with extended reality applications according to some embodiments. In an XR head-mounted display device 140, a control module 142 controls a display 144, which may be an LCD, to display an image. The image is focused by one or more lenses of display optics 146 to make the image visible to the user. In the example of FIG. 1C, exterior light does not reach the user's eyes directly. However, in some such embodiments, an exterior camera 148 may be used to capture images of the exterior environment and display such images on the display 144 together with any virtual content that may also be displayed.

The embodiments described herein are not limited to any particular type or structure of XR display device.

FIG. 1D is a system diagram illustrating an example set of interfaces for a system according to some embodiments. An extended reality display device, together with its control electronics, may be implemented using a system such as the system of FIG. 1D. System 150 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 150, singly or in combination, can be embodied in a single integrated circuit (IC), multiple ICs, and/or discrete components. For example, in at least one embodiment, the processing and encoder/decoder elements of system 150 are distributed across multiple ICs and/or discrete components. In various embodiments, the system 150 is communicatively coupled to one or more other systems, or other electronic devices, via, for example, a communications bus or through dedicated input and/or output ports. In various embodiments, the system 1000 is configured to implement one or more of the aspects described in this document.

The system 150 includes at least one processor 152 configured to execute instructions loaded therein for implementing, for example, the various aspects described in this document. Processor 152 may include embedded memory, input output interface, and various other circuitries as known in the art. The system 150 includes at least one memory 154 (e.g., a volatile memory device, and/or a non-volatile memory device). System 150 may include a storage device 158, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 158 can include an internal storage device, an attached storage device (including detachable and non-detachable storage devices), and/or a network accessible storage device, as non-limiting examples.

System 150 includes an encoder/decoder module 156 configured, for example, to process data to provide an encoded video or decoded video, and the encoder/decoder module 156 can include its own processor and memory. The encoder/decoder module 156 represents module(s) that can be included in a device to perform the encoding and/or decoding functions. As is known, a device can include one or both of the encoding and decoding modules. Additionally, encoder/decoder module 156 can be implemented as a separate element of system 150 or can be incorporated within processor 152 as a combination of hardware and software as known to those skilled in the art.

Program code to be loaded onto processor 152 or encoder/decoder 156 to perform the various aspects described in this document can be stored in storage device 158 and subsequently loaded onto memory 154 for execution by processor 152. In accordance with various embodiments, one or more of processor 152, memory 154, storage device 158, and encoder/decoder module 156 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 152 and/or the encoder/decoder module 156 is used to store instructions and to provide working memory for processing that is needed during encoding or decoding. In other embodiments, however, a memory external to the processing device (for example, the processing device can be either the processor 152 or the encoder/decoder module 152) is used for one or more of these functions. The external memory can be the memory 154 and/or the storage device 158, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 150 can be provided through various input devices as indicated in block 172. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 172 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 150 to other electronic devices across USB and/or HDMI connections. It is to be understood that various aspects of input processing, for example, Reed-Solomon error correction, can be implemented, for example, within a separate input processing IC or within processor 152 as necessary. Similarly, aspects of USB or HDMI interface processing can be implemented within separate interface ICs or within processor 152 as necessary. The demodulated, error corrected, and demultiplexed stream is provided to various processing elements, including, for example, processor 152, and encoder/decoder 156 operating in combination with the memory and storage elements to process the datastream as necessary for presentation on an output device.

Various elements of system 150 can be provided within an integrated housing, Within the integrated housing, the various elements can be interconnected and transmit data therebetween using suitable connection arrangement 174, for example, an internal bus as known in the art, including the Inter-IC (12C) bus, wiring, and printed circuit boards.

The system 150 includes communication interface 160 that enables communication with other devices via communication channel 162. The communication interface 160 can include, but is not limited to, a transceiver configured to transmit and to receive data over communication channel 162. The communication interface 160 can include, but is not limited to, a modem or network card and the communication channel 162 can be implemented, for example, within a wired and/or a wireless medium.

Data is streamed, or otherwise provided, to the system 150, in various embodiments, using a wireless network such as a Wi-Fi network, for example IEEE 802.11 (IEEE refers to the Institute of Electrical and Electronics Engineers). The Wi-Fi signal of these embodiments is received over the communications channel 162 and the communications interface 160 which are adapted for Wi-Fi communications. The communications channel 162 of these embodiments is typically connected to an access point or router that provides access to external networks including the Internet for allowing streaming applications and other over-the-top communications. Other embodiments provide streamed data to the system 150 using a set-top box that delivers the data over the HDMI connection of the input block 172. Still other embodiments provide streamed data to the system 150 using the RF connection of the input block 172. As indicated above, various embodiments provide data in a non-streaming manner. Additionally, various embodiments use wireless networks other than Wi-Fi, for example a cellular network or a Bluetooth network.

The system 150 can provide an output signal to various output devices, including a display 176, speakers 178, and other peripheral devices 180. The display 176 of various embodiments includes one or more of, for example, a touchscreen display, an organic light-emitting diode (OLED) display, a curved display, and/or a foldable display. The display 176 can be for a television, a tablet, a laptop, a cell phone (mobile phone), or other device. The display 176 can also be integrated with other components (for example, as in a smart phone), or separate (for example, an external monitor for a laptop). The other peripheral devices 180 include, in various examples of embodiments, one or more of a stand-alone digital video disc (or digital versatile disc) (DVR, for both terms), a disk player, a stereo system, and/or a lighting system. Various embodiments use one or more peripheral devices 180 that provide a function based on the output of the system 150. For example, a disk player performs the function of playing the output of the system 150.

In various embodiments, control signals are communicated between the system 150 and the display 176, speakers 178, or other peripheral devices 180 using signaling such as AV.Link, Consumer Electronics Control (CEC), or other communications protocols that enable device-to-device control with or without user intervention. The output devices can be communicatively coupled to system 1000 via dedicated connections through respective interfaces 164, 166, and 168. Alternatively, the output devices can be connected to system 150 using the communications channel 162 via the communications interface 160. The display 176 and speakers 178 can be integrated in a single unit with the other components of system 150 in an electronic device such as, for example, a television. In various embodiments, the display interface 164 includes a display driver, such as, for example, a timing controller (T Con) chip.

The display 176 and speaker 178 can alternatively be separate from one or more of the other components, for example, if the RF portion of input 172 is part of a separate set-top box. In various embodiments in which the display 176 and speakers 178 are external components, the output signal can be provided via dedicated output connections, including, for example, HDMI ports, USB ports, or COMP outputs.

The system 150 may include one or more sensor devices 168. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 150 is used as the control module for an extended reality display (such as control modules 124, 132), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 152 or by hardware, or by a combination of hardware and software. As a non-limiting example, the embodiments can be implemented by one or more integrated circuits. The memory 154 can be of any type appropriate to the technical environment and can be implemented using any appropriate data storage technology, such as optical memory devices, magnetic memory devices, semiconductor-based memory devices, fixed memory, and removable memory, as non-limiting examples. The processor 152 can be of any type appropriate to the technical environment, and can encompass one or more of microprocessors, general purpose computers, special purpose computers, and processors based on a multi-core architecture, as non-limiting examples.

### Scene Description Framework for XR

The present principles generally relate to the domain of rendering of extended reality scene description and extended reality rendering. The present document is also understood in the context of the formatting and the playing of extended reality applications when rendered on end-user devices such as mobile devices or Head-Mounted Displays (HMD).

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way which is consistent with the user context (environment, point of view, device, etc.). Scene graphs (such as the one proposed by Khronos/gITF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand.

Although such MPEG scene description frameworks ensure that the timed media and the corresponding relevant virtual content are available at any time during the rendering of the application, there is no description of how a user can interact with the scene objects at runtime for immersive XR experiences.

There is a lack of an XR system that can take an XR scene description including metadata describing how a user can interact with the scene objects at runtime and how these interactions may be updated during runtime of the XR application.

In XR applications, a scene description is used to combine explicit and easy-to-parse description of a scene structure and some binary representations of media content.

In time-based media streaming, the scene description itself may be time-evolving to provide the relevant virtual content for each sequence of a media stream. For instance, for advertising purpose, a virtual bottle may be displayed during a video sequence where people are drinking.

For some embodiments, the framework described in the document, Scene Description for MPEG Media Document, Information Technology—Coded Representation of Immersive Media—Part14: Scene Description for MPEG Media, International Organization for Standardization (ISO), ISO/IEC DIS 23090-14:2021 (E) (2021), may be used.

### Runtime Interactivity

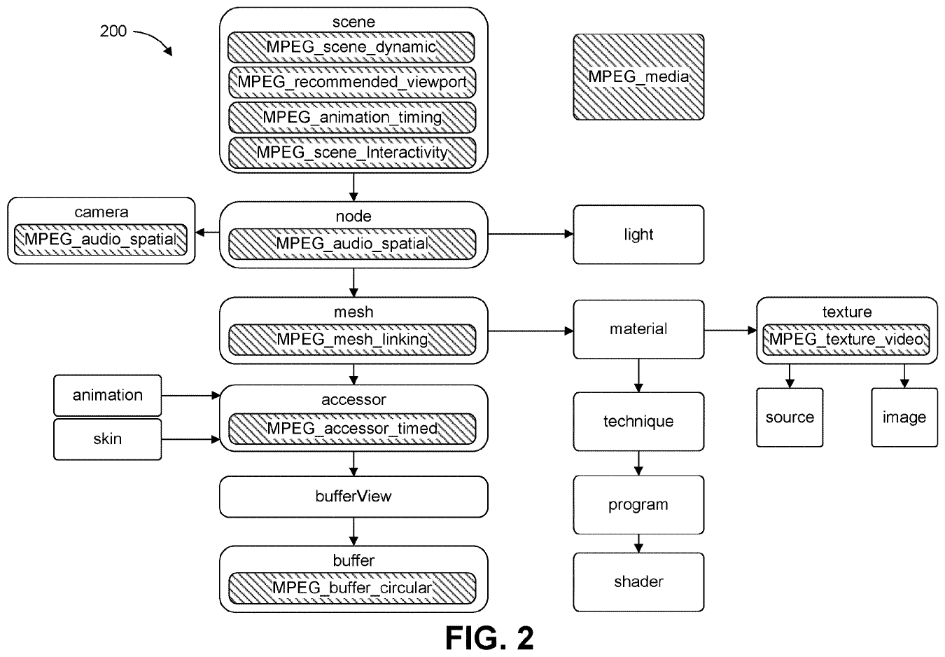

FIG. 2 is a system diagram illustrating an example set of interfaces for an MPEG-I node hierarchy supporting elements of scene interactivity according to some embodiments. According to the present principles, some of which are shown in the node hierarchy 200, in addition to a node tree, behavior metadata items (examples of what are herein called ‘behaviors’) are added to the scene description. In example embodiments, the time-evolving scene description is augmented by adding information identifying behaviors. These behaviors may be related to pre-defined virtual objects on which runtime interactivity is allowed for user specific XR experiences.

In some embodiments, these behaviors are time-evolving. In such embodiments, the behaviors may be updated through the already-existing scene description update mechanism.

In example embodiments, a behavior may be characterized by one or more of the following properties:
One or more triggers defining the conditions to be met for activation.
A trigger control parameter defining the logical operations between the defined triggers.
Actions to be implemented in response to the activation of the triggers.
An action control parameter defining the order of execution of the defined actions.
A priority number enabling the selection of the behavior of highest priority in the case of concurrence of several behaviors on the same virtual object at the same time.
An interrupt action to specify how to terminate this behavior when the behavior is no longer defined in a newly received scene update. For instance, a behavior is no longer defined if the related object has been removed or if the behavior is no longer relevant for this current media (e.g. audio or video) sequence.

With the addition of these behaviors, time-dependent user interactivity in immersive content for XR experiences may be defined.

When a second scene description is received, some of the behaviors of the first scene description may be “on-going”, e.g., they are triggered, and their actions are running. The second scene description may be provided as update metadata, e.g., metadata describing the differences between the first scene description and the second description. The second scene description includes a node tree describing objects that may be common or different than objects of the first scene descriptions. Objects of the node tree of the first scene description may be no longer present in the second description. If the objects related to the running actions of the on-going behaviors are missing in the second scene description, then, these on-going behaviors are no longer appliable. If an on-going behavior is not defined in the second description, the on-going behavior is no longer appliable. The interrupt action field describes how to interrupt the running actions on the on-going behavior.

In XR applications, a scene description is used to combine explicit and easy-to-parse description of a scene structure and some binary representations of media content.

In this application, a User Equipment (UE) may correspond to any extended Reality (XR) device/node which may come in a variety of form factors. A typical UE (e.g., an XR UE) may include, but is not limited to, the following items: Head Mounted Displays (HMDs), optical see-through glasses and camera see-through HMDs for AR and MR, mobile devices with positional tracking and camera, and wearables. In addition to the above items, several different types of XR UE may be used based on XR device functions, e.g., display, camera, sensors, sensor processing, wireless connectivity, XR/Media processing, and power supply, and may be provided by one or more devices, wearables, actuators, controllers and/or accessories. One or more device/nodes/UEs may be grouped into a collaborative XR group for supporting XR applications/experience/services.

### System Architecture

In the specification SUPPORT OF 5G GLASS-TYPE AUGMENTED REALITY/MIXED REALITY (AR/MR) DEVICES, 3rd Generation Partnership Project (3GPP), TR26.998, Release 17.1.0 (September 2022), the 3GPP Technical Specification Group Services and System Aspects Working Group 4 (SA4) has defined the system architectures for the interactive immersive services. Different degrees of split workflow between the AR devices and the Cloud/Edge are identified, which results in the definition of two main device types: 5G Standalone AR UE (STAR) and 5G Edge dependent AR UE (EDGAR).

### 5G Standalone AR UE (STAR)

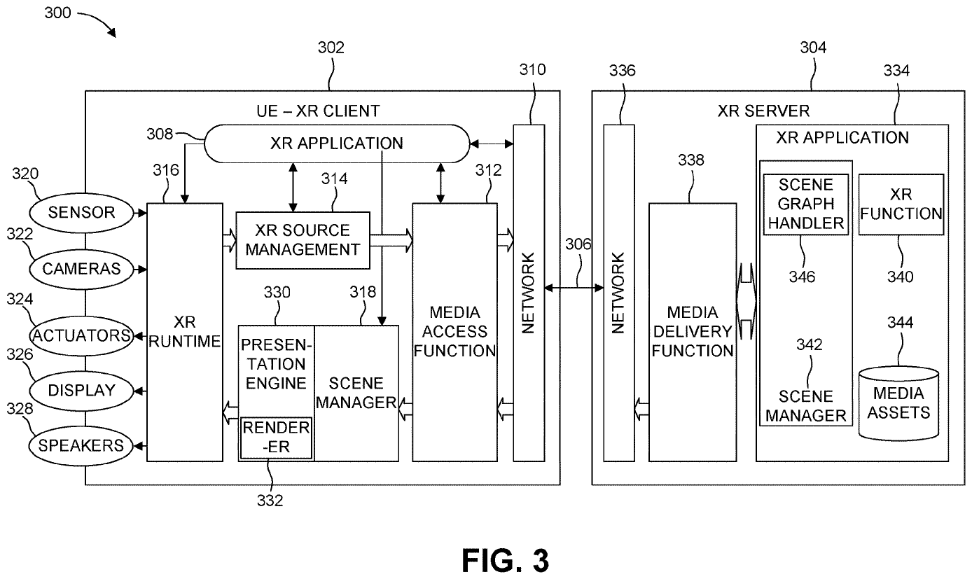

FIG. 3 is a system diagram illustrating an example set of interfaces for standalone augmented reality (STAR)-based 5G interactive immersive service according to some embodiments. FIG. 3 provides an architecture 300 for immersive interactive media distribution using a STAR UE. On the left side of FIG. 3 is a UE device 302, which may serve as an XR client for some embodiments. The right side of FIG. 3 shows an XR server 304, and the UE 302 and the XR server 304 may be connected by a network 306, which is shown in the center of FIG. 3. Inside the UE/XR client, an XR application 308 may be running. The XR application 308 may have bi-directional access to a network interface 310, a Media Access Function 312, and an XR Source Management block 314. The XR application 308 also may interface to an XR Runtime block 316 and a Scene Manager block 318.

For some embodiments, the XR runtime block 316 may interface with one or more sensors 320, one or more cameras 322, one or more actuators 324, one or more displays 326, one or more speakers 328, one or more user interfaces (such as a pad controller), one or more lights, and one or more buttons for some embodiments. For some embodiments, the XR runtime 316 may receive information from a presentation engine 330 and/or a scene manager 318. The Presentation Engine 330 may include a renderer block 332.

For some embodiments, a user action or other input may be received by the XR Runtime block 316. Such user action or other input may be passed to the XR Source Management block 314, on to the Media Access Function (MAF) 312, and further on to the Network block 310 for transmission to the XR Server 304. For some embodiments, an interaction response or other message may be received by the Network block 310. Such information may be passed to the Media Access Function (MAF) 312 and on to the Presentation Engine 330.

Inside the XR server 304, an XR application 334 may be running. The XR application 334 may have di-directional access to the network interface 336 and a Media Delivery Function 338. Within the XR application 334 running on the XR server 304, an XR function 340 and a scene manager 342 may be running. The XR application 334 may also have access to media assets 344. Within the Scene Manager block 342, a Scene Graph Handler 346 may exist. The Media Delivery Function 338 for the XR Server 305 may have bi-directional access to the network interface 336 and to the XR application 334.

### 5G Edge Dependent AR UE (EDGAR)

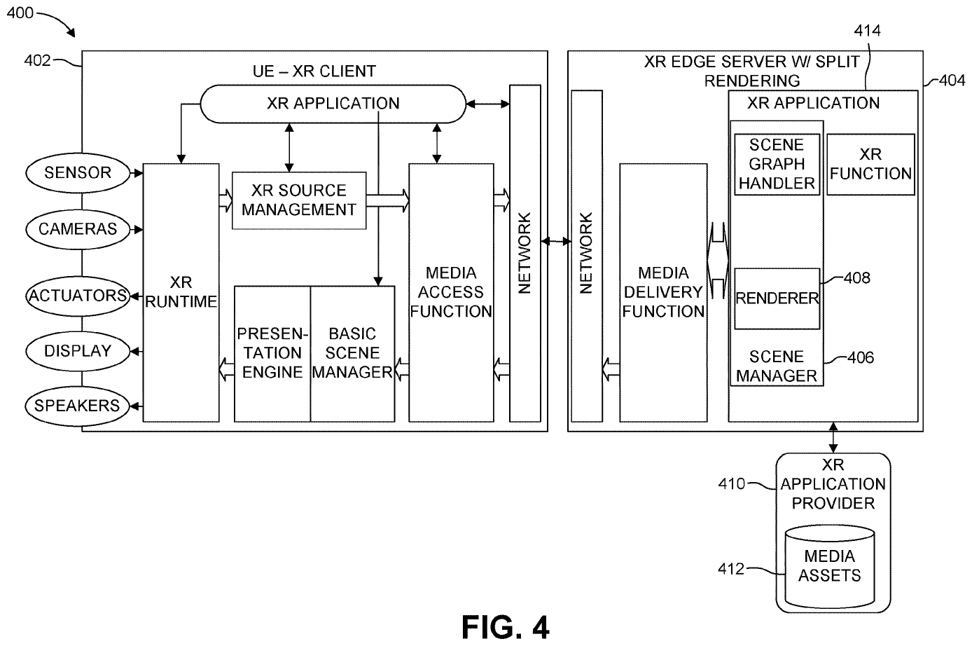

FIG. 4 is a system diagram illustrating an example set of interfaces for EDGe-dependent AR (EDGAR)-based 5G interactive immersive service according to some embodiments. FIG. 4 provides an architecture 400 for Interactive Immersive Media distribution using an EDGAR UE 402. In this case, most of the rendering is accomplished on a server 404.

Comparing FIGS. 3 and 4, most of the interfaces are the same but there are a few differences. For information about the items that are the same, see the description of FIG. 3. Regarding the differences, FIG. 3 shows a renderer block 332 within the UE's presentation engine block 330. In FIG. 4, the server's scene manager block 406 shows an immersive renderer block 408. Additionally, FIG. 3 shows the media assets 344 within the XR server's XR application block 334, while FIG. 4 shows an XR application provider 410 with the media assets 412 and a bi-directional interface to XR application block 414.

### Interactive Immersive Services

For some embodiments, such as shared interactive immersive services, the user interaction is sent from a UE to a server. The user interaction may be a single event which may be asynchronous from other data flows. Furthermore, the frequency of occurrence of the interaction event depends on the type of interaction and the use case. The server handles the user's request to the immersive media scene (e.g., by changing the context, such as the translation, rotation, and/or scaling, or by adding a new object in the scene).

With the UE standalone configuration, the UE is able to render the scene and the server sends to the UE the processed scene. For some embodiments, the processed scene is sent as a scene description update file. For some embodiments, the processed scene is sent as a full new scene description.

With the edge assisted UE configuration, which may be called split rendering, the UE offloads the scene rendering to the server. The server rasterizes the XR viewport and does pre-rendering to generate the XR media, which is encoded and delivered to the UE.

### Interactivity Delay and QoE

In the context of interactive immersive services, estimating the user quality of experience may use the roundtrip interaction delay, which is defined in the document EXTENDED REALITY (XR) IN 5G, 3rd Generation Partnership Project (3GPP), TR26.928, Release 17.0.0 (April 2022) (“3GPP TR26.928”) (See section 4.2.2, Interaction Delays and Age of Content). For some embodiments, the roundtrip interaction delay is an important parameter for estimating the user quality of experience. The roundtrip interaction delay is the sum of the User Interaction Delay and the Age of Content. For some embodiments, the roundtrip interaction delay itself may be used as a Quality of Experience (QoE) metric.

The User Interaction Delay is the time duration between the moment a user action is initiated and the time such an action is processed and taken into account by the content creation engine. The User Interaction Delay may be impacted by the uplink latency of the wireless network.

The Age of Content is the time duration between the moment the content is created and the time when the content is presented to the user. The Age of Content may be impacted by the downlink latency of the wireless network.

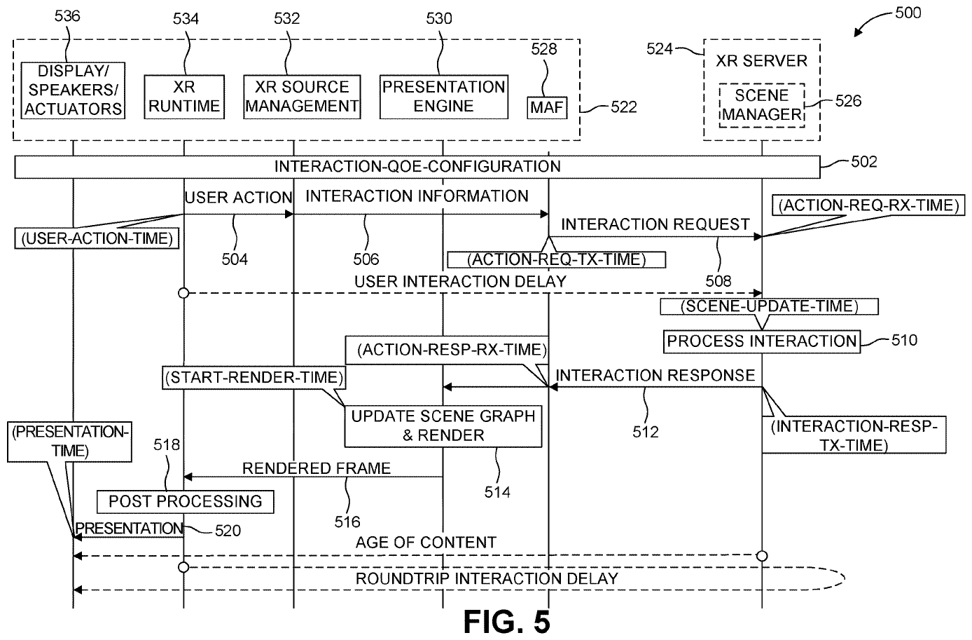

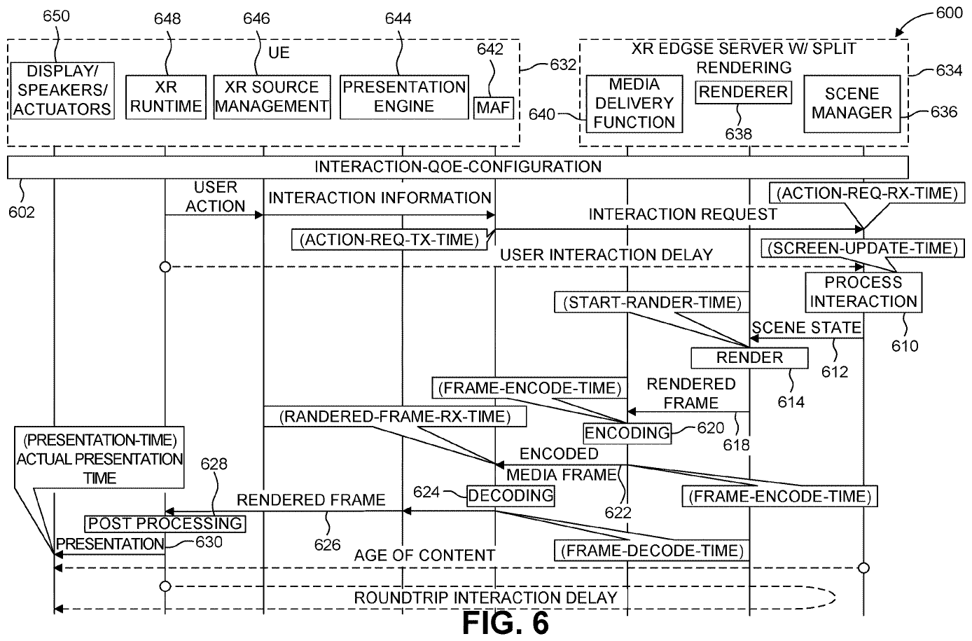

FIGS. 5 and 6, which are discussed later in the application, both show the User Interaction Delay, the Age of Content, and the roundtrip interaction delay

For some embodiments, the interactivity Quality of Experience (QoE) is highly dependent on the roundtrip interaction delay and the use case. Table 4.2.2-1 from 3GPP TR26.928, which is reproduced here as Table 1, provides, for example, roundtrip interaction delay tolerance thresholds per game type.

TABLE 1

| | | Delay | |
|---|---|---|---|
| Example Game Type | Perspective | Tolerance | |
| First person shooter (FPS) | First person | 100 | ms |
| Role playing game (RPG) | Third person | 500 | ms |
| Real-time strategy (RTS) | Omnipresent | 1000 | ms |

For some embodiments, the latency of the content, for example, is determined by conversational delay thresholds. Typically, around 200 ms of latency is acceptable. Overall, different applications and use cases have different delay requirements.

Table 2 lists the four categories of interaction/application with respect to roundtrip interaction delay:

TABLE 2

| Interaction/Application | Roundtrip interaction | |
|---|---|---|
| Categories | delay threshold | |
| Ultra-Low-Latency | ≤50 | ms |
| Low-Latency | ≤100 | ms |
| Moderate latency | ≤200 | ms |
| Non-critical latency | >200 | ms |

Several interactions with different roundtrip interaction delay thresholds may coexist in an application.

openXR interaction

The standard The OpenXR Specification, Khronos OpenXR Working Group (Version 1.0.27), available at registry<dot>khronos<dot>org/openxr/specs/1.0/html/xrspec<dot>html #input (“Khronos OpenXR”) provides an API for access to VR/AR platforms and devices. One of the elements of this API is the XrActions element, which is used to handle user interactions.

The current state of an input action may be obtained by calling the xrGetActionState* function, which returns an XrActionState* structure, including the lastChangeTime timestamp of the last change to the state of this action. The lastChangeTime timestamp corresponds to the time when the user performed the action.

The estimation of the Interactivity QoE characteristic is linked to the measurement of the roundtrip interaction delay. The openXR API exposes the time when the user performs the action, but the UE application has no means, without a specified procedure, to know when this action is taken into account by the server and when the server receives the interaction response.

Monitoring contributions of the different steps through the wireless network, UE, and server process blocks to the whole delay is important. The different delay contributions due to the processing pipeline may include processing time in the UE and in the server and transmission time through the wireless network for both uplink and downlink. By knowing this information, an application may make some adaptations through the processing pipeline to optimize resources of the UE, the network (uplink and downlink), and the server/edge for a target interactivity QoE.

For some embodiments, such as within the context of a 5G application, monitoring of the different delays may include specifying that timing metadata exchanged between the UE and the server include an interactivity-QoE metric, which may be shared with the 5G network.

This application discusses adding timestamp and identifier metadata to an interaction request from user equipment (UE) to an edge/server and to an interaction response from the edge/server to the UE. The UE and the server may exchange interactivity-QoE metadata with the interaction request and response. At each step of the process, the UE and the edge/server applications may record the time and send the time together with the interaction data. Such functionality allows measurement of the delay of each step through the network and estimates the contribution of each step to the user interactivity quality of experience. Measurement of the variation over time of the different delays may help with optimizing steps and increasing efficiency, such as steps with the highest delay variation. The server replicates the interactivity-QoE metadata received from the UE and attaches the metadata to processing output messages sent back to the UE. The persistence of the interactivity-QoE metadata through the interaction processing pipeline may be helpful to measuring delays.

### Interaction-QoE Configuration

Configuration of the interaction-QoE may be done between the UE and the server during application initialization, which may include setting up one or more application sessions. Such configuration may include setting where, how, and in what format the interaction-QoE is measured and reported.

The UE and the server negotiate the configuration of the interaction-QoE for each interaction indicated in the application. For example, the configuration may include which interaction timestamps will be recorded through interaction processing pipeline. This timestamp recording granularity may depend on several factors, such as the interaction category, which is shown above in Table 2, and/or the frequency of occurrence of the interaction.

### Measurement of Time Delay in a STAR Architecture

FIG. 5 is a message sequencing diagram illustrating an example process for user interaction with a standalone XR device according to some embodiments. For the 5G Standalone AR (STAR) device type, the scene manager in the server maintains a consistent scene between multiple users. The server scene manager 526 periodically sends the scene state to the UE Presentation Engine 530, which updates the scene graph and renders the scene following the latest user pose.

FIG. 5 shows an example procedure 500 for an interactivity timeline/pipeline. For some embodiments, the XR application on both the UE 522 and the server 524 is already initialized and all sessions are established and configured. FIG. 5 does not show the user poses and other sensor timelines/pipelines, but such actions may still occur. The following process 500 corresponds to FIG. 5.

The UE 522 and the server 524 configure 502 the interaction-QoE.

The raw user action 504 is acquired from the XR runtime 534 by the XR source management 532.

The XR source management 532 formats the raw user action into an interaction information including the interactivity-QoE metadata. The user-action-time timestamp and a unique identifier of the interaction user-action-id are appended to the interactivity-QoE metadata. The interaction information 506 is shared with the Media Access Function (MAF) 528.

The MAF 528 sends the interaction request 508 to the Scene Manager 526 in the XR Server 524. The MAF 528 appends the action-req-TX-time timestamp to the interactivity-QoE metadata.

The interaction request is received by the XR server 524 and buffered before being handled during the next iteration of the update loop of the Scene Manager 526. The Scene Manager 526 in the server 524 processes the interaction task according to the interaction request from the UE 522 and updates the scene. The Scene Manager 526 records in the interactivity-QoE metadata the scene-update-time timestamp when the Scene Manager 526 starts to process 510 the interaction request. Using the information in the interactivity-QoE metadata, the server application may calculate Eqns. 1 and 2:

$$User Interaction Delay = Scene Update Time - User Action Time \qquad ( 1 )$$

$$Tx Action Delay = Scene Update Time - Action Request Tx Time \qquad ( 2 )$$

The Scene Manager 526 may ignore the interaction requests 508 according to the application policy: too many requests, request too late or lower priority. In this case, the interactivity-QoE metadata including the user-action-id of the dropped interactions may be appended to the interactivity-QoE metadata of the next interaction response to inform the UE. The interaction-done field is set to TRUE if the interaction was processed by the scene manager, otherwise the integration-done field is set to FALSE.

Depending on the level of processing, the interaction response 512 may be a scene description update or a new scene description. The interaction response can provide user feedback related to the interaction task (e.g., virtual hands, virtual ray, sounds and haptic feedback). The interaction response is sent to the UE Presentation Engine 530. With the interaction response, the server includes the interactivity-QoE metadata from the interaction request and appends its timestamp: scene-update-time and the interaction-resp-TX-time timestamp when the response is sent.

When the UE MAF 528 receives the interaction response, the UE application records the interaction-resp-RX-time timestamp and extracts the interactivity-QoE metadata associated with the interaction response. The transmission time through the downlink wireless network may be estimated by using the interaction-resp-TX-time. The Presentation Engine 530 updates 514 the scene graph or loads a new scene depending on the interaction request. The Presentation Engine 530 renders the scene at the next iteration of the update loop. The start-render-time when the scene starts to be rendered is captured by the application and appended to the interactivity-QoE metadata.

The rendered frame 516 is shared to the XR runtime 534.

The XR runtime 534 performs further post-processing 518 before presentation to the user.

The rendered frame with the interaction response is presented 520 to the user via the display, speakers, and/or actuators 536. The application captures the presentation-time.

### Measurement of Time Delay in an EDGAR Architecture

FIG. 6 is a message sequencing diagram illustrating an example process for user interaction with an XR edge server with split rendering according to some embodiments.

For a 5G Edge dependent AR (EDGAR) device type, the scene manager in the server maintains a consistent scene between multiple users. The server scene manager is in charge to pre-render the scene for the UE using the latest user pose. The server scene manager also encodes the rendered frame and sends the encoded frame back to the UE. The UE decodes the rendered frame, performs further post-processing, such as pose correction, and presents the frame to the user.

FIG. 6 shows an example procedure for an interactivity timeline/pipeline. For some embodiments, the XR application on both the UE and the server is already initialized and all sessions are established and configured. FIG. 6 does not show the user poses and other sensor timelines/pipelines, but such actions may still occur. The following process 600 corresponds to FIG. 6.

The UE 632 and the Server 634 configures 602 the interaction-QoE

The raw user action 604 is acquired from the XR Runtime 648 by the XR Source Management 646.

The XR Source Management 646 formats the raw user action 604 into an interaction information including the interactivity-QoE metadata. The user-action-time timestamp and a unique identifier user-action-id are appended to the interactivity-QoE metadata. The interaction information 606 is shared with the Media Access Function (MAF) 642.

The MAF 642 sends the interaction request 608 to the Scene Manager 636 in the XR Server 634. The MAF 642 appends the action-req-TX-time timestamp to the interactivity-QoE metadata.

The interaction request 608 is received by the XR Server 634 and buffered before being handled during the next iteration of the update loop of the Scene Manager 636. The Scene Manager 636 at the server processes the interaction task according to the interaction request from the UE 632 and updates the scene. The Scene Manager 636 records the scene-update-time timestamp when the Scene Manager 636 starts to process 610 the interaction request. Using the information in the interactivity-QoE metadata, the server application may calculate Eqns. 3 and 4:

$$User Interaction Delay = Scene Update Time - User Action Time \qquad Eq . 3$$

$$Tx Action Delay = Scene Update Time - Action Request Tx Time \qquad Eq . 4$$

As in the STAR architecture (FIG. 5), the Scene Manager 636 may ignore the interaction requests 608 according to application policy. The interaction-done field is set to TRUE if the interaction was processed by the scene manager, otherwise the integration-done field is set to FALSE.

The Scene Manager 636 shares the scene state 612 with the renderer 638 in the server 634.

The scene is rendered using the last predicted user pose. When the scene starts to be rendered 614, the start-render-time is captured by the application and stored in the interactivity-QoE metadata.

The rendered media frame 618 is shared with the Media Delivery Function 640.

The Server Media Delivery Function 640 encodes 620 the rendered media frame. The Server Media Delivery Function 640 records the frame-encode-time when the Server Media Delivery Function 640 starts encoding 620 the frame and appends this timestamp to the interactivity-QoE metadata which is associated with the media frame.

The encoded media frame 622 is sent from the Server MDF 640 to the UE MAF 642 with the interactivity-QoE metadata. The server records the rendered-frame-TX-time timestamp when the server sends the rendered media frame to the UE 632 and appends the rendered-frame-TX-time timestamp to the interactivity-QoE metadata.

The UE MAF 642 receives and captures the rendered-frame-TX-time time in the interactivity-QoE metadata, then the MAF 642 decodes 624 the rendered media frame.

The rendered frame 626 is shared to the Presentation Engine 644 and XR Runtime 648. The UE application captures the frame-decoded-time time in the interactivity-QoE metadata.

The XR Runtime 648 performs further post-processing 628, such as pose correction before presenting the frame to the user.

The rendered frame with the interaction response is presented 630 to the user via the display, speakers, and/or actuators 650. The application captures the presentation-time.

### Interactivity QoE Processing Model:

Using the timestamps in the interactivity-QoE metadata from the server and in the UE, the UE application, for example, may calculate Eqns. 5-8, which include:

$$User Interaction Delay = Scene Update Time - User Action Time \qquad Eq . 5$$

$$Tx Action Delay = Scene Update Time - Action Request Tx Time \qquad Eq . 6$$

$$Age of Content = Presentation Time - Scene Update Time \qquad Eq . 7$$

$$Roundtrip Interaction Delay = Presentation Time - User Action Time \qquad Eq . 8$$

For some embodiments, the UE application may use the interaction identifier user-action-id to calculate the Roundtrip Interaction Delay by storing the time when the user performed the interaction with this identifier. Using the interaction identifier user-action-id in the interactivity-QoE response, the UE application may determine whether the user interaction was taken into account or dropped/ignored by the server. The dropping rate may be used as a QoE metric. The interaction identifier user-action-id also may be used to check the processing order of the interactions in the server.

Some timestamps and delays may be not available, according to the timestamp recording granularity specified in the configuration. For example, for a certain type of interaction, the application may be configured to not record the start render time. For this type of interaction, the server may measure the scene update time to frame encode time delay, which corresponds to the interaction processing+scene rendering delay. In that case, the interaction processing delay and the scene rendering delay may not be measured.

The UE reports to the server the resulting interactivity-QoE metadata with all the roundtrip interaction timestamps. The UE and the server applications may use that report to optimize the user QoE for the next user interactions.

A fine optimization of the network and computing resources of the interaction pipeline may use the timestamps in the interactivity-QoE metadata. That optimization may depend on the category of interaction/application with respect to the roundtrip interaction delay threshold described in Table 2.

For example, if the interaction is in the non-critical latency category, the wireless network latency on the uplink may be relaxed to free some radio resources for other more latency critical data flows. The application may report the interaction-QoE to the Edge server, and the QoE aware Edge resource orchestration may allocate computing power to other processes.

### Interactivity-QoE Metadata Format

The interactivity-QoE metadata may be composed of several fields, which depend on the system architecture. The device types, standalone (STAR) or Edge dependent (EDGAR), have specific delays and timestamps, but there are also delays and timestamps common to both configurations. The item interaction QoESets is the name of the container that holds each of the elements shown in Table 3. For some embodiments, the interactivity-QoE metadata structure may be a JSON format, for example, and may follow the syntax and semantics shown in Table 3.

TABLE 3

| Name | Type | Cardinality | Description |
|---|---|---|---|
| version | number | 1 . . . 1 | The version of the interactivity-QoE metadata. |
| interaction QoESets | object | 1 . . . n | An array of interactions QoE. |
| user-action-id | string | 1 . . . 1 | A unique identifier of the user action that this |
| | | | message contains. |
| interaction-done | boolean | 1 . . . 1 | Acknowledgement of the interaction. |
| | | | TRUE if the interaction was processed by the |
| | | | scene manager. |
| user-action-time | number | 1 . . . 1 | The timestamp when the user performs the |
| | | | action. The timestamp may correspond to |
| | | | lastChangeTime timestamp in the |
| | | | XrActionState* structure of the API described in |
| | | | Khronos OpenXR. |
| action-req-TX-time | number | 0 . . . 1 | The time when the UE sends the Interaction |
| | | | request. |
| action-req-RX-time | number | 0 . . . 1 | The time when the server receives the |
| | | | Interaction request. |
| scene-update-time | number | 0 . . . 1 | Start time when the Interaction request is |
| | | | processed by the scene manager in the |
| | | | server/edge. |
| start-render-time | number | 0 . . . 1 | The time when the scene starts to be rendered, |
| | | | either at the UE or at the server/edge as |
| | | | applicable. |
| presentation-time | number | 0 . . . 1 | The time when the rendered frame with the |
| | | | interaction response is presented to the user. |
| interaction-resp-TX-time | number | 0 . . . 1 | The timestamp of the transmission from the |
| | | | server of the Interaction response (scene |
| | | | update or new scene). |
| interaction-resp-RX-time | number | 0 . . . 1 | The timestamp of the reception by the UE of the |
| | | | Interaction response (scene update or new scene). |
| frame-encode-time | number | 0 . . . 1 | The time when the rendered frame starts to be |
| | | | encoded. |
| rendered-frame-TX-time | number | 0 . . . 1 | The timestamp of the transmission from the |
| | | | server through the wireless network of the |
| | | | encoded media frame. |
| rendered-frame-RX-time | number | 0 . . . 1 | The timestamp of the reception by the UE of the |
| | | | encoded media frame. |
| frame-decoded-time | number | 0 . . . 1 | The time when rendered media frame is decoded |
| | | | by the UE. |

### Transport

For some embodiments, the RTP header extension may be used to carry the interactivity-QoE metadata when he interactivity-QoE metadata is associated with the rendered media frame in the media stream (video or audio) over RTP, which is typically the case with a split rendering device type in the downlink.

For some embodiments, the WebRTC data channel may be used to send the interactivity-QoE metadata with the interaction request or response when there is no associated media stream.

Aspects of the present application may be detected via a dedicated semantic described in:
MEDIA CAPABILITIES FOR AUGMENTED REALITY (MECAR), 3rd Generation Partnership Project (3GPP), TR26.119, Version 0.1.0 (April 2022);
MECAR PERMANENT DOCUMENT V5.1, 3rd Generation Partnership Project (3GPP), Version 5.1, available at www<dot>3gpp<dot>org/ftp/tsg_sa/wg4_codec/3gpp_sa4_ahoc_mtgs/sa4_video/docs/s4av230017<dot>zip (Specification); and/or.
MECAR PERMANENT DOCUMENT V5.1, 3rd Generation Partnership Project (3GPP), Version 5.1, available at www<dot>3gpp<dot>org/ftp/tsg_sa/wg4_codec/3gpp_sa4_ahoc_mtgs/sa4_video/docs/s4av230017<dot>zip (Figures).

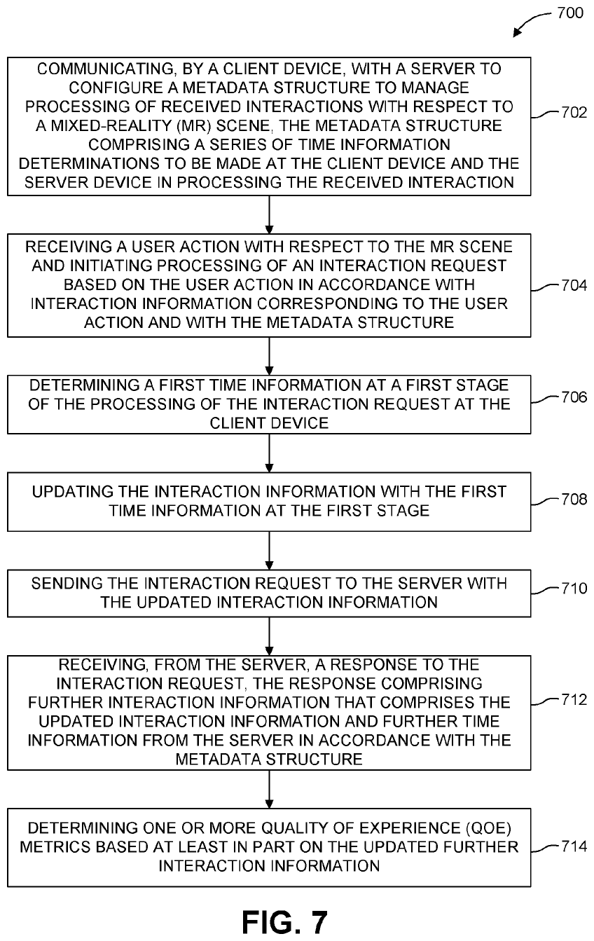

FIG. 7 is a flowchart illustrating an example process for determining a quality of experience metric according to some embodiments. For some embodiments, an example process 700 may include communicating 702, by a client device, with a server to configure a metadata structure to manage processing of received interactions with respect to a mixed-reality (MR) scene, the metadata structure comprising a series of time information determinations to be made at the client device and the server device in processing the received interaction. For some embodiments, the example process 700 may further include receiving 704 a user action with respect to the MR scene and initiating processing of an interaction request based on the user action in accordance with interaction information corresponding to the user action and with the metadata structure. For some embodiments, the example process 700 may further include determining 706 a first time information at a first stage of the processing of the interaction request at the client device. For some embodiments, the example process 700 may further include updating 708 the interaction information with the first time information at the first stage. For some embodiments, the example process 700 may further include sending 710 the interaction request to the server with the updated interaction information. For some embodiments, the example process 700 may further include receiving 712, from the server, a response to the interaction request, the response comprising further interaction information that comprises the updated interaction information and further time information from the server in accordance with the metadata structure. For some embodiments, the example process 700 may further include determining 714 one or more Quality of Experience (QoE) metrics based at least in part on the updated further interaction information.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

An example method in accordance with some embodiments may include communicating, by a client device, with a server to configure a metadata structure to manage processing of received interactions with respect to a mixed-reality (MR) scene, the metadata structure comprising a series of time information determinations to be made at the client device and the server device in processing the received interaction; receiving a user action with respect to the MR scene and initiating processing of an interaction request based on the user action in accordance with interaction information corresponding to the user action and with the metadata structure; determining a first time information at a first stage of the processing of the interaction request at the client device; updating the interaction information with the first time information at the first stage; sending the interaction request to the server with the updated interaction information; receiving, from the server, a response to the interaction request, the response comprising further interaction information that comprises the updated interaction information and further time information from the server in accordance with the metadata structure; and determining one or more Quality of Experience (QoE) metrics based at least in part on the updated further interaction information.

Some embodiments of the example method may further include determining a second time information at a second stage of the processing of the interaction request at the client device; and updating the interaction information with the second time information at the second stage.

For some embodiments of the example method, at least one of the first time information and the second time information may include one or more timestamps.

Some embodiments of the example method may further include determining a second time information at a second stage of the processing of the response from the server at the client device; and updating the further interaction information from the response from the server with the second time information at the second stage

Some embodiments of the example method may further include receiving an identifier code; and determining a configuration of the metadata structure based on the received identifier code.

Some embodiments of the example method may further include receiving an identifier code; and using the identifier code to check processing order of user interactions at the server.

Some embodiments of the example method may further include receiving an identifier code; and determining a roundtrip interaction delay using the identifier code.

For some embodiments of the example method, determining the roundtrip interaction delay may include storing a time when a user performed an interaction associated with the identifier code.

Some embodiments of the example method may further include determining an interaction request drop rate, wherein the interaction drop rate may include a rate at which interaction requests are dropped by the server, and wherein the interaction request drop rate may include a QoE metric.

For some embodiments of the example method, at least one of the one or more QoE metrics may be a roundtrip interaction delay.

For some embodiments of the example method, the response nay include an updated description of the MR scene.

For some embodiments of the example method, the response may include a new description of the MR scene.

For some embodiments of the example method, the response may include information indicating the interaction request was dropped by the server.

For some embodiments of the example method, the response may include an encoded version of a rendered MR scene.

For some embodiments of the example method, the further time information may further include from stages of processing at the server.

An example apparatus in accordance with some embodiments may include a processor; and a non-transitory computer-readable medium storing instructions operative, when executed by the processor, to cause the apparatus to perform one of the methods listed above.

An additional example method in accordance with some embodiments may include receiving, by a server, communications from a client device, to configure a metadata structure to manage processing of user interactions with respect to a mixed-reality (MR) scene, the metadata structure comprising a series of time information determinations to be made at the client device and the server device in processing the received interaction; receiving, at the server, an interaction request with interaction information, wherein the interaction information comprises a first time information at a first stage of processing of the interaction request at the client device; determining, at the server, a further time information at a second stage of the processing of the interaction request; sending, to the client device, a response to the interaction request, the response comprising further interaction information that comprises the interaction information and the further time information from the server in accordance with the metadata structure; wherein one or more Quality of Experience (QoE) metrics are based at least in part on the further interaction information.

For some embodiments of the additional example method, at least one of the first time information and the further time information may include one or more timestamps.

Some embodiments of the additional example method may further include receiving an identifier code; and determining a configuration of the metadata structure based on the received identifier code.

Some embodiments of the additional example method may further include receiving an identifier code; and using the identifier code to check processing order of user interactions at the server.

Some embodiments of the additional example method may further include receiving an identifier code; and determining a user interaction delay using the identifier code.

For some embodiments of the additional example method, determining the user interaction delay may include receiving a time when a user performed an interaction associated with the identifier code.

Some embodiments of the additional example method may further include determining an interaction request drop rate, wherein the interaction drop rate may include a rate at which interaction requests are dropped by the server, and wherein the interaction request drop rate may include a QoE metric.

For some embodiments of the additional example method, at least one of the one or more QoE metrics may be a user interaction delay.

For some embodiments of the additional example method, the response may include an updated description of the MR scene.

For some embodiments of the additional example method, the response may include a new description of the MR scene.

For some embodiments of the additional example method, the response may include information indicating the interaction request was dropped by the server.

For some embodiments of the additional example method, the response may include an encoded version of a rendered MR scene.

For some embodiments of the additional example method, the further time information may further include from stages of processing at the server.

Some embodiments of the additional example method may further include receiving the one or more Quality of Experience (QoE) metrics that are based at least in part on the further interaction information.

An additional example apparatus in accordance with some embodiments may include a processor; and a non-transitory computer-readable medium storing instructions operative, when executed by the processor, to cause the apparatus to perform any one of the claims listed above.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
communicating, by a client device, with a server to configure a metadata structure to manage processing of received interactions with respect to a mixed-reality (MR) scene, the metadata structure comprising a series of time information determinations to be made at the client device and the server in processing the received interactions;
receiving a user action with respect to the MR scene and initiating processing of an interaction request based on the user action in accordance with interaction information corresponding to the user action and with the metadata structure;
determining a first time information at a first stage of the processing of the interaction request at the client device;
updating the interaction information with the first time information at the first stage;
sending the interaction request to the server with updated interaction information;
receiving, from the server, a response to the interaction request, the response comprising further interaction information that comprises the updated interaction information and further time information from the server in accordance with the metadata structure; and
determining one or more Quality of Experience, QoE, metrics based at least in part on the updated further interaction information.

2. The method of claim 1, further comprising:
determining a second time information at a second stage of the processing of the interaction request at the client device; and
updating the interaction information with the second time information at the second stage.

3. The method of claim 2, wherein at least one of the first time information and the second time information comprises one or more timestamps.

4. The method of claim 1, further comprising:
determining a third time information at a third stage of processing of the response from the server at the client device; and
updating the further interaction information from the response from the server with the third time information at the third stage.

5. The method of claim 1, further comprising:
receiving an identifier code; and
determining a configuration of the metadata structure based on the received identifier code.

6. The method of claim 1, further comprising:
receiving an identifier code; and
using the identifier code to check processing order of user interactions at the server.

7. The method of claim 1, further comprising:
receiving an identifier code; and
determining a roundtrip interaction delay using the identifier code.

8. The method of claim 7, wherein determining the roundtrip interaction delay comprises storing a time when a user performed an interaction associated with the identifier code.

9. The method of claim 1, further comprising:
determining an interaction request drop rate,
wherein the interaction request drop rate comprises a rate at which interaction requests are dropped by the server, and
wherein the interaction request drop rate comprises at least one of the one or more QoE metrics.

10. The method of claim 1, wherein at least one of the one or more QoE metrics is a roundtrip interaction delay.

11. The method of claim 1, wherein the response comprises an updated description of the MR scene.

12. The method of claim 1, wherein the response comprises a new description of the MR scene.

13. The method of claim 1, wherein the response comprises information indicating the interaction request was dropped by the server.

14. The method of claim 1, wherein the response comprises an encoded version of a rendered MR scene.

15. The method of claim 1, wherein the further time information further comprises from stages of processing at the server.

16. An apparatus comprising:
a processor; and
a non-transitory computer-readable medium storing instructions operative, when executed by the processor, to cause the apparatus to:
communicate, by a client device, with a server to configure a metadata structure to manage processing of received interactions with respect to a mixed-reality (MR) scene, the metadata structure comprising a series of time information determinations to be made at the client device and the server in processing the received interactions;
receive a user action with respect to the MR scene and initiating processing of an interaction request based on the user action in accordance with interaction information corresponding to the user action and with the metadata structure;
determine a first time information at a first stage of the processing of the interaction request at the client device;
update the interaction information with the first time information at the first stage;
send the interaction request to the server with updated interaction information;
receive, from the server, a response to the interaction request, the response comprising further interaction information that comprises the updated interaction information and further time information from the server in accordance with the metadata structure; and
determine one or more Quality of Experience (QoE) metrics based at least in part on the updated further interaction information.

17. A method comprising:
receiving, by a server, communications from a client device, to configure a metadata structure to manage processing of user interactions with respect to a mixed-reality (MR) scene, the metadata structure comprising a series of time information determinations to be made at the client device and the server in processing the received interactions;
receiving, at the server, an interaction request with interaction information,
wherein the interaction information comprises a first time information at a first stage of processing of the interaction request at the client device;
determining, at the server, a further time information at a second stage of the processing of the interaction request; and
sending, to the client device, a response to interaction request, the response comprising further interaction information that comprises the interaction information and the further time information from the server in accordance with the metadata structure;
wherein one or more Quality of Experience, QoE, metrics are based at least in part on the further interaction information.

18-21. (canceled)

22. The method of claim 17, further comprising:
receiving an identifier code; and
determining a user interaction delay using the identifier code,
wherein determining the user interaction delay comprises receiving a time when a user performed an interaction associated with the identifier code.

23. (canceled)

24. The method of claim 17, wherein at least one of the one or more QoE metrics is a user interaction delay.

25-29. (canceled)

30. The method of claim 17, further comprising receiving the one or more QoE metrics that are based at least in part on the further interaction information.

31. (canceled)
